(19) United States
(12) Patent Application Publication
(10) Pub. No.: US 2020/0299152 A1
(43) Pub. Date: Sep. 24, 2020

(54) COMBINED WATER HEATER AND WATER TREATMENT UNIT

(71) Applicant: ORBITAL SYSTEMS AB, MALMÖ (SE)

(72) Inventors: Joakim OSCARSON, VEJBYSTRAND (SE); Tobias SÖDERBERG, HELSINGBORG (SE)

(21) Appl. No.: 16/462,833

(22) PCT Filed: Nov. 22, 2017
(86) PCT No.: PCT/SE2017/051153

§ 371 Date: May 21, 2019

(30) Foreign Application Priority Data
Nov. 25, 2016 (SE) 1651548-8

(51) Int. Cl. C02F 1/32; C02F 1/02; F24D 17/00; F24D 19/10; F24H 1/18; H05B 3/36

(52) U.S. Cl. CPC C02F 1/325; C02F 1/02; F24D 17/0073; F24D 19/1051; F24D 2200/08; H05B 3/36; C02F 2303/04; C02F 2201/3223; F24H 1/185

(57) ABSTRACT

The present invention describes a combined water heater and water treatment device 1, said combined water heater and water treatment device comprising a water treatment unit 2 being embedded by a single container 3 of the combined water heater and water treatment device 1, and said combined water heater and water treatment device 1 also comprising a heater element 4 arranged on the outside of the single container 3 of the combined water heater and water treatment device.

### FIELD OF THE INVENTION

The present invention relates to a combined water heater and water treatment unit, especially intended for a system allowing for purification and recycling of water or separation of water.

### TECHNICAL BACKGROUND

There are of course known systems where water heating and treatment are involved, also in systems where purification and recycling of water or separation of water are involved. One example is disclosed in WO2013/095278 which describes a hybrid device for a recirculation shower comprising a filter system with a nano-filter. In WO2013/095278 the treatment is made by filtration and heating is performed in a flow-through water heater.

One main purpose of the present invention is to provide a combined water heater and water treatment unit.

### SUMMARY OF THE INVENTION

The latter stated purpose above is achieved by a combined water heater and water treatment device, said combined water heater and water treatment device comprising a water treatment unit being embedded by a single container of the combined water heater and water treatment device, and said combined water heater and water treatment device also comprising a heater element arranged on the outside of the single container of the combined water heater and water treatment device.

One advantage of the present invention is the compact arrangement. This implies that less space is needed. Furthermore, the use of only a single container and providing the heater on the outside of that single container also provides the advantage of less components needed and creates a simple arrangement in relation to installation and maintenance.

This is different when being compared to another type of arrangement, such as the one disclosed in JP8164385, where the heating is performed in a heating tube creating an outer container of the device. As notable, also the heating unit as such is different, where a film is used according to the present invention and an external heating tube is used in the device according to JP8164385.

Another example is disclosed in CN104556271A, but in this case the heater element seems to be arranged on the inside of the wall.

### BRIEF DESCRIPTION OF THE DRAWINGS

FIG. 1 shows a combined water heater and water treatment device according to one specific embodiment of the present invention.

FIG. 2 shows part of a system allowing for purification and recycling of water or separation of water, wherein said system comprises a combined water heater and water treatment device according to the present invention placed above a water filtration unit in terms of process flow.

FIG. 3 shows one example of a full system allowing for purification and recycling of water or separation of water comprising a combined water heater and water treatment device according to the present invention.

### SPECIFIC EMBODIMENTS OF THE INVENTION

Below specific embodiment of the present invention are disclosed.

The actual water treatment unit according to the present invention may vary in terms of technology and function. According to one specific embodiment, the water treatment unit comprises granulate. These granulates then have a disinfection function which is intended to purify the water.

According to yet another specific embodiment of the present invention, the water treatment unit is a light unit or a radiation unit. In this case, different form of light is the treating medium. The light unit may be a LED unit, UV-LED unit or a conventional UV unit. Furthermore, the wavelength and color of the light should be set to optimize for the treatment of water to purify it from contaminants.

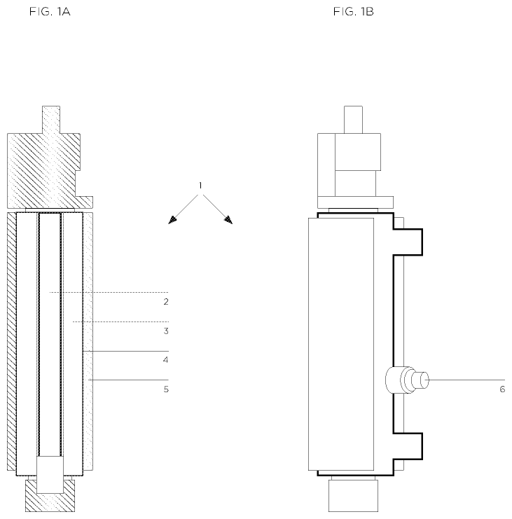

According to one specific embodiment, the light unit is a UV unit, e.g. a UV lamp. In this case the combined water heater and water treatment device according to the present invention preferably also comprises a UV sensor which at least gives an indication of the function of the UV treatment. If a sufficient amount of light reaches the UV sensor, this is an indication that light penetrates the water flow space contained inside the water treatment unit. In the case of a UV lamp, then preferably this is surrounded by a transparent protective cover, e.g. made of a plastic or glass material, such as a quartz glass, to make sure not to contaminate the UV lamp. The space between the quartz glass and the inside wall of the single container holds the water to be treated. The UV light is intended to penetrate all of that space as effectively as possible. Therefore, it is important to make sure that the UV lamp and also the quartz glass is free from contaminants and fouling. Therefore, to enable cleaning of the transparent protective cover is of importance in relation to the present invention. Therefore, according to one specific embodiment of the present invention, the light unit is a UV lamp being surrounded by a transparent protective cover and wherein both the UV lamp and the transparent protective cover are removable from the bottom of the single container. This functionality may be seen in FIGS. 1A and 1B where it can be seen that it is possible to remove the UV lamp and protective cover from the bottom by removing a protective bottom cap. In one example, it may also be possible to remove the UV lamp and protective cover from the top by removing a protective top cap. As illustrated, two caps, one in each end, can be used.

According to another specific embodiment of the present invention there is arranged a cleaning unit in the form of a brush, wiper or scraper rotating around and cleaning the outside of the transparent protective cover.

According to yet another specific embodiment of the present invention, the heater element of the present invention is one coherent single unit. To arrange the heater element as one single unit is of interest to simplify the entire device. As current is intended to be fed to the heater element it is of course of interest only to use one electric connection instead of multiple.

According to yet another specific embodiment of the present invention, the heater element is embedded in isolation. The isolation may comprise different material and have different size etc. As an example, a size of around 10 mm may be sufficient to embed the heater element in an effective way.

According to yet another specific embodiment of the present invention, the heater element is a film attached to a portion of the outside surface of the single container. The use of one coherent single heater film is preferable to provide an effective and compact device according to the present invention.

The present invention also has other possible features. According to one specific embodiment, the combined water heater and water treatment device has one or more electricity safety functions. Possible alternatives are e.g. earthing of the container cover and a thermostat connected to the container cover, where the latter stops the power supply during a short circuit or overheating.

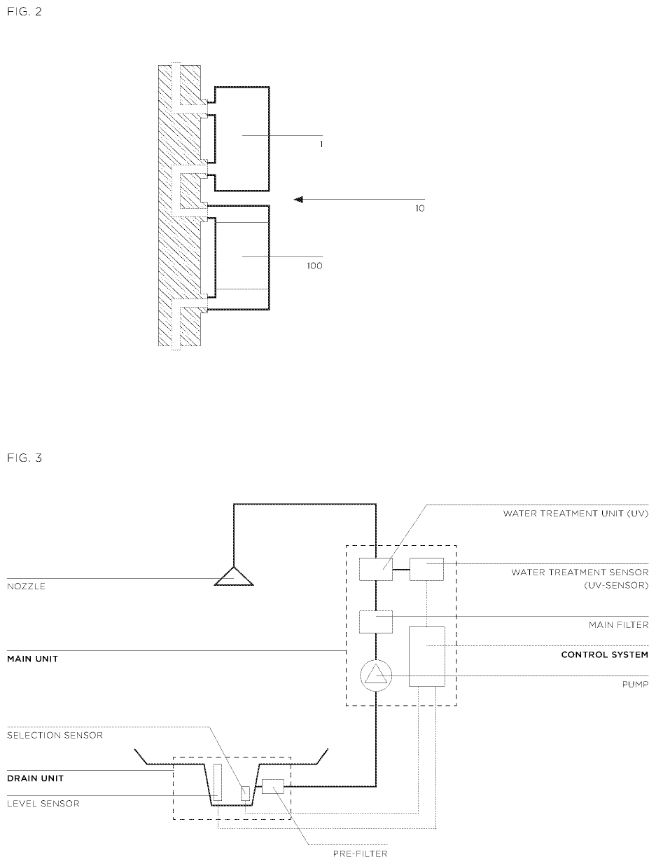

Moreover, according to another specific embodiment of the present invention both an inflow and an outflow of the combined water heater and water treatment device are arranged on the side of the device. This decreases the needed height when installing the device, which is beneficial. This is further seen for example in FIG. 2 of the drawings.

The above disclosed features are also some other differences between the present invention when being compared to CN104556271A.

The present invention also refers to a system allowing for purification and recycling of water or separation of water, comprising a combined water heater and water treatment device according to the present invention. According to one specific embodiment of the present invention, the combined heater and water treatment unit is arranged subsequent a water filtration unit in terms of process flow in such a system allowing for purification and recycling of water or separation of water.

According to one embodiment of the present invention, and as seen in FIG. 2, the combined water heater and water treatment device is placed in a vertically higher position than the water filtration unit in such a system. The water flow is directed to be fed into the bottom of the filtration unit, fed through the filtration unit and out from the top of the same, then further into the combined heater and water treatment unit at the bottom of the same to be treated and then finally after treatment fed out from the combined heater and water treatment unit at the top thereof.

The vertical positioning of the filtration unit and combined heater and water treatment unit in that order has several advantages. First of all, this arrangement enables back-flushing of the filter unit, and also the combined heater and water treatment unit, by draining water in the system from the top to the bottom by using gravity. Secondly, such a draining of the filtration unit also implies that the draining is performed from a cleaner part of the filtration unit to a dirtier side thereof, which also is beneficial. Repeated filling and draining enables a cleaning cycle which, if needed, can be made more potent using a chemical solution. Furthermore, when filling the system from bottom to top, then air in the system is transported the same direction. As such, there is no need to ventilate the system and there is minimal risk for air pockets.

According to yet another specific embodiment of the present invention, there is disclosed a method for allowing for purification and recycling of water or separation of water in a system intended therefore, said method comprising:

a first step being selection step where clean water in accordance with a set water standard is recirculated in the system and contaminated water is separated off;

a second step being a rough filtration which is performed by use of a pre-filter;

a third step being a mid and fine filtration by use of a disposable main filter; and

a fourth step being a water treatment by use of a water treatment unit;

wherein the combined water heater and water treatment unit is evacuated after the system has been used.

In relation to the expression “has been used” this implies when a user is finished with the system, such as in the case of a shower system after a shower.

The system according to the method according to the present invention comprises a combined water heater and water treatment unit, e.g. comprising a UV unit such as a UV lamp, but also a filter system comprising a pre-filter and a disposable main filter, a drain, a sensor system and a control system and a pump and piping etc.

The pre-filter may be back-flushed to continuously prevent particles from clogging the filter medium. The pre-filter may also be temporarily removed to be manually cleaned if this is needed.

If water is separated off, as is decided in the control system based on indications form a sensor system, it is sent out from the system via the drain. According to yet another specific embodiment of the present invention, the disposable main filter is evacuated after the system has been used. According to yet another specific embodiment of the present invention, also the UV treatment unit is evacuated after the system has been used. This is performed so as to prolong the durability of the disposable main filter and to counteract growth on the filter.

### DETAILED DESCRIPTION OF THE DRAWINGS

FIG. 1A shows a combined water heater and water treatment device 1 comprising a water treatment unit 2 positioned inside a single container 3 of the combined water heater and water treatment device 1, and a heater element 4, in this case in the form of a heater film, arranged on the outside of the single container 3 of the combined water heater and water treatment device 1. Furthermore, the heater film 4 is embedded in isolation 5.

Moreover, as shown in FIGS. 1A and 1B the light unit 2 is in the form of a UV lamp. Furthermore, and as seen in FIG. 1B there is provided a UV sensor 6 to detect the light penetration through the water in the single container 3.

FIG. 2 shows part of a system 10 allowing for purification and recycling of water or separation of water, wherein said system 10 comprises a combined water heater and water treatment device 1 according to the present invention placed above a water filtration unit 100 in terms of process flow.

FIG. 3 shows a full system 10 allowing for purification and recycling of water or separation of water, in this case a shower. The system 10 comprises a main unit comprising a combined water heater and water treatment device 1 (mentioned as water treatment unit) and a main filter 100. As notable, the water treatment unit has a water treatment sensor which is connected to a control system. Other sensors in the system are sensors in the drain of the system 10. These are also connected to the control system. As such it is possible to integrate several sensors.

As an example, the system 10 comprises a combined water heater and water treatment unit 1 comprising a UV unit, which unit 1 is connected to a UV sensor. Moreover, the system 10 also comprises a filter system comprising a main filter being a mid/fine filter and a pre-filter, e.g. a removable mesh filter. Furthermore, a pump, control system, nozzle (and/or handheld shower) and of course piping is also arranged in the system 10. In the drain unit, there are provided a second sensor type being a main “selection sensor”, selection referring to the selection of recirculating or separation of water, and also a third sensor type being a level sensor. Both of these sensors are also connected to the control system.

1. Combined water heater and water treatment device, said combined water heater and water treatment device comprising a water treatment unit being embedded by a single container of the combined water heater and water treatment device, and said combined water heater and water treatment device also comprising a heater element arranged on the outside of the single container of the combined water heater and water treatment device.

2. Combined water heater and water treatment device according to claim 1, wherein the water treatment unit comprises granulate.

3. Combined water heater and water treatment device according to claim 1, wherein the water treatment unit is a light unit.

4. Combined water heater and water treatment device according to claim 3, wherein the light unit is a UV unit.

5. Combined water heater and water treatment device according to claim 3, wherein the light unit is a UV lamp being surrounded by a transparent protective cover and wherein both the UV lamp and the transparent protective cover are removable from the bottom of the single container.

6. Combined water heater and water treatment device according to claim 1, wherein the heater element is one coherent single unit.

7. Combined water heater and water treatment device according to claim 1, wherein the heater element is embedded in isolation.

8. Combined water heater and water treatment device according to claim 1, wherein the heater element is a film attached to a portion of the outside surface of the single container.

9. Combined water heater and water treatment device according to claim 1, wherein the single container is earthed and is arranged with a thermostat to stop power supply during a short circuit or overheating.

10. Combined water heater and water treatment device according to claim 1, wherein an inflow and an outflow of the combined water heater and water treatment device is arranged on the side thereof.

11. System allowing for purification and recycling of water or separation of water, said system comprising a combined water heater and water treatment device according to claim 1 and wherein the combined heater and water treatment device is arranged subsequent a water filtration unit in terms of process flow.

12. System according to claim 11, wherein the combined water heater and water treatment device is placed in a vertically higher position than the water filtration unit.
